(19) United States
(12) Patent Application Publication
(10) Pub. No.: US 2004/0021101 A1
(43) Pub. Date: Feb. 5, 2004

(54) Method and apparatus for radiographic imaging

(75) Inventor: Troy W. Livingston, Northbrook, IL (US)

Correspondence Address: FITCH EVEN TABIN AND FLANNERY, 120 SOUTH LA SALLE STREET, SUITE 1600, CHICAGO, IL, 60603-3406, US

(73) Assignee: Essex Electro Engineers, Inc.

(21) Appl. No.: 10/281,822

(22) Filed: Oct. 28, 2002

Related U.S. Application Data
(63) Continuation-in-part of application No. 09/990,164, filed on Nov. 21, 2001.
Application No. 09/990,164 is a continuation-in-part of application No. PCT/US01/20481, filed on Jun. 27, 2001.
Application No. PCT/US01/20481 is a continuation-in-part of application No. 09/721,014, filed on Nov. 22, 2000, now Pat. No. 6,555,838.
(60) Provisional application No. 60/214,930, filed on Jun. 29, 2000.

(51) Int. Cl. G03B 42/08

(52) U.S. Cl. 250/588

(57) ABSTRACT

An apparatus and method for computed radiography includes an optical pump source which may be a plurality of light emitting diodes or a movable laser. Pumping light from the optical pump source is carried through each of a plurality of optical fibers arranged in a linear array to a previously-exposed computed radiography plate having a latent X-ray image formed thereon. The plate is moved with respect to the fibers. Light emitted from the radiographic medium due to excitation by the pumping light supplies the emitted light to an optical receiver where an image signal responsive to the light intensity of the emitted light is generated. The image signal is sent to a processor to generate an image representative of the latent X-ray. An erasing of the latent x-ray image may be accomplished in the same machine apparatus that generates the representative image. Preferably, multiple erasure operations are performed with a relaxation period, e.g., three to ten seconds between successive erasing operations. The preferred system is modular in construction in the sense that the diameter of the ring of transmit fibers is a multiple to allow for different lengths of linear fiber ends with the fiber ends held in precise positions both at the linear end of the cut drum and at the other arcuate end of the cut drum. A transmitting fiber head is formed by wrapping a fiber about a cylinder drum and bonding the adjacent windings of fiber together and to the drum by a bonding material such as potting compound. The drum is cut longitudinally and one cut end is arranged arcuately to have first cut ends of the fiber winding disposed about an axis and the other ends of the fibers are disposed in a linear array.

### CROSS REFERENCE TO RELATED APPLICATIONS

This is a continuation-in-part of U.S. patent application Ser. No. 09/990,164, filed Nov. 21, 2001, which is a continuation-in-part of International Patent Application No. PCT/US01/20481, filed Jun. 27, 2001, designating the United States of America, which is a continuation-in-part of co-pending U.S. patent application Ser. No. 09/721,014, filed Nov. 22, 2000, which claimed priority from U.S. Provisional Patent Application No. 60/214,930, filed Jun. 29, 2000. International Application No. PCT/US01/20481 also claimed priority from U.S. Provisional Patent Application No. 60/214,930, filed Jun. 29, 2000.

### BACKGROUND OF THE INVENTION

The invention generally relates to radiographic imaging and, more particularly, relates to a method and apparatus for reading a computed radiography phosphor plate or sheet that has been exposed by X rays by supplying pumping light thereto.

It is well known that, by using X-ray systems, features can be visualized within the human body or within industrial products, or the like. Current X-ray systems often use X-ray film which must be developed.

In the alternative, computed tomography installations are available but are very expensive and require large amounts of computer power.

In addition systems exist which use a technique called computed radiography. A patient or object is exposed with X rays and a latent X-ray image is formed on a phosphor-containing computed radiography plate or sheet that is similar to a sheet of film. The phosphor-containing sheet typically may include a rare earth, such as europium, in combination with barium and fluorine. Other sheet formulations also are available. The sheet is sensitive to X rays and can store a latent X-ray image thereon. Because the sheet is also sensitive to light it is kept in the dark. A sheet containing a latent X-ray image is imaged in a scanner by exposing the sheet and its latent image to a raster-scanned laser beam. Areas of the sheet which have preferentially received X-ray energy phosphorus, making the latent X-ray image visible.

While the scanner is convenient and allows reuse of the computed radiography sheets multiple numbers of times, it does suffer from certain drawbacks. It is difficult to obtain a high-spatial resolution image because the pumping laser beam, although only covering a small spot-size at a time, tends to leave illumination energy behind, which causes bloom; thereby smearing the image and reducing its resolution. This is because the image is built up in the way that an image would be in a flying spot device wherein only a single optical detector is used. The single optical detector can capture radiation from almost any position on the sheet. The optical detector, however, is unable to determine whether the photons it is receiving are coming from unwanted bloom or coming from active phosphorescence caused by excitation by the laser beam.

In addition the existing systems either operate in the laser visible region at about 630 to 650 nanometers or, in the near infrared region, at about 940 nanometers. A single laser cannot be used for both wavelengths. Because there are differing types of latent imaging materials used for computed radiography, not all phosphorus either with red pumping light or with infrared pumping light. A scanner which uses a pumping laser in either the red or infrared region cannot accept plates or sheets having latent images which must be optically pumped in the other region.

The prior raster-scanned laser systems introduce spatial non-linearities in the image for which there must be compensation. The non-linearities are due to the difference in the effective beam scan rate when the beam is substantially perpendicular to the latent image containing sheet at the center portion of the sheet and when it is sweeping at an angle to the sheet near the sheet edges. As a result, since the image is constructed based upon on pumping beam timing and orientation, elaborate methods would have to be used in order to effectively relinearize the beam scan to provide an undistorted image.

U.S. Pat. No. 4,737,641 discloses an apparatus for producing x-ray images by computer tomography using a high energy excitation beam such as a red laser beam which is focused on the storage plate by suitable optics and the beam is deflected across a line of the plate by a rotating mirror. The storage plate is shifted in steps relative to the fan of the laser beam so that the entire image is read line-by-line by the x-ray beam. The photo-stimulated luminescence is successively supplied point-by-point to a common photomultiplier and then to an amplifier via a light conductor comprising a plurality of optical fibers. The emissions are connected into electrical signals are supplied to analog-to-digital converters and a computer forms an image that is visible on a display unit.

A particular problem with systems using the rotating mirror to deflect the laser beam across the line is that vibrations jiggle the mirror and cause a loss of sensitivity or tolerance. An acceptable tolerance is often only 0.004 inch which can be a problem when the mirror is being vibrated. Further, these rotating mirror and focusing lens systems require a light-sealed, large volume or space within an enclosed housing. Further, such systems may be too delicate to be used in the field such as for military x-rays of wounded soldiers or for being carried into remote rugged locations for non-military use. Thus, there is a need for a smaller and more rugged apparatus for producing x-ray images by computer tomography.

A further shortcoming of existing computer tomography, x-ray imaging systems is that of erasure of the latent images to allow reuse of the plate. Heretofore, the used plates were taken to a separate erasure machine where they are exposed to illumination at a certain frequency. The problem arises that residual images are often left on the plate even after having sent through the erasure machine. A particularly difficult problem for current erasure apparatus is to erase hard, sharp edges of images on the plate. It may be difficult to distinguish in a non-destructive testing as to whether or not the image is a crack or a residual ghost from a previous image or an actual flaw in the piece being x-rayed. Often, the user has to take a second x-ray image and observe whether or not the suspected residual image crack or the like fails to reappear because it was a residual ghost from a previous exposure to x-rays. Some shapes or materials such as titanium pins will leave images that are difficult to erase. In situations as non-destructive imaging of computer chips, pipes or the like, the elimination of residual images is very necessary. Hence, there is a need for a new and improved erasing system.

Another problem with current apparatus is that they do not provide sufficient resolution. Often the resolution is only 4-6 line pairs per millimeter. For some uses, a resolution of 11 line pairs per millimeter is desirable in order to expand the use of x-ray images by computer radiography.

Another shortcoming of existing apparatus is that they are limited to handling only one size of plate. There is a need for a system that can handle more than one size of plate or that can be built modularly so as to be adapted and built for different sizes of plates. Typically, these plates range from six by eight inches for the smallest plate to fourteen by seventeen for the larger plates.

What is needed, then, is a system and apparatus which can quickly and conveniently provide highly-accurate and high resolution computed radiography visible images without the need for expensive equipment.

### SUMMARY OF THE INVENTION

In accordance with the present invention there is provided a new and improved apparatus for radiographic imaging. This is achieved by using a rotating laser rotating past fixed fiber optic ends which deliver the light to the radiographic medium with an optical collector such as an array of optical receiving fibers or a light pipe receiving phosphorescent light from the radiographic medium for delivery to an optical receiver which is connected to a processor for generating the image. More specifically, it is preferred to fix the input ends of the optical pumping fibers in a circular array about the rotating laser.

In accordance with another aspect of the invention, the optical pumping fibers have their delivery ends aligned in a linear array and a motor causes the plate or radiographic medium to be moved under the linear fiber array as it is exposed to the pumping light from the fibers. In addition the fibers are multiplexed in groups of 64 so that there is no unwanted bloom from one excitation or pumping fiber to the next at any one time. This improves the optical resolution provided by the pumping light.

A second plurality of optical fibers or a light pipe collects the emitted light and delivers the emitted light to a photo diode or other optical transducer which changes the light intensity to an electrical signal. That signal is supplied to a processor which generates an image signal. The image signal may then be used to generate an image representative of the latent x-ray image on the radiographic substrate.

In accordance with another important aspect of the invention, the apparatus is provided with an erasing device for erasing the residual latent images from the medium after it has been read. Herein, the plate is fed directly from the image forming and reading station into an erasing station at a constant rate of speed to perform immediately a first erasing operation. Then, the previously erased area is allowed to relax for a predetermined period of time, e.g., about 3 seconds and then it is erased a second time while in the machine. The erasure is by exposure to certain wavelengths, e.g., orange light. The relaxation period appears to work on a molecular level to allow more latent energy dissipation than can be accomplished with a longer erasure radiation or two successive erasures without any relaxation between erasure exposures. Herein, a first light seal separates the pumped and emitted light from a first erasing station and a light seal separates a downstream second erasing station from the first erasing station. A period of about three seconds separates an area on the sheet from its first and second erasures to provide for the desired molecular relaxation between these erasures. Manifestly, additional relaxation periods and further erasures could be performed.

In accordance with another aspect of the invention, the apparatus is provided in modular forms of potted transmit fibers that are potted in a predetermined width, e.g., four inches so that common hardware and multiples of the potted fibers may be used to read plates that are 4.0; 8.6 or 17 inches across.

In accordance with the preferred embodiment of the invention, a rotating laser rotates past the fixed potted ends of optical fibers which deliver light at their opposite ends arrayed in a straight line across the radiographic medium. The phosphorescent light emitted from the medium is received by a light pipe which delivers the phosphorescent light to an optical receiver for producing output signals that are sent to a processor for generating image signals to generate an image on a display device or a film. In this embodiment, first and second erasure stations having bulb sources therein are separated and apart at locations that allow a relaxation between erasure exposures.

In accordance with a further embodiment of the invention, there is disclosed an apparatus and method for radiographic imaging wherein a substrate comprising a computed radiography plate or sheet is exposed to X rays to form a latent image thereon. The apparatus comprises an optical pump source which is a plurality of light emitting diodes (LEDs). The LEDs emit light at two visible wavelengths and one infrared wavelength. The pumping light from the LEDs is supplied to a plurality of transmit optical fibers which deliver the pumping light to the computed radiography sheet being scanned. A laser carried on a rotating platform can sequentially illuminate ends of the transmit fibers to supply coherent pumping light thereto.

The transmit optical fibers have their delivery ends aligned in a linear array adjacent the position at which they deliver pumping light to the computed radiography sheet. A motor causes the sheet to be moved under the transmit linear fiber array as the sheet is exposed to the pumping light from the transmit fiber ends. In addition, when the LEDs are used as the illumination source the transmit fibers are multiplexed in groups of sixty four, to provide relatively wide spacing between transmit fiber ends that are simultaneously pumping light to the sheet. This avoids bloom from one excitation or pumping fiber to the next at any one time and improves the optical resolution provided by the pumping light.

Preferably a light pipe, or alternatively, receive optical fibers collect the emitted light and supplies it to photodiodes or other optical transducers, such as a photomultiplier tube, which generate an image signal representative of light intensity. That signal is supplied to a processor which generates an image signal. The image signal may then be used to generate a visible image representative of the latent x-ray image on the radiographic substrate.

In a further embodiment of the present invention the apparatus will include a unitary light pipe comprised of a single piece of substantially transparent plastic although glass or other transparent material can be substituted. The light pipe can collect all light available along a scan line at the computed radiography plate and carry it to a photodetector, usually a photomultiplier, for conversion to an electrical signal. With this type of construction most of the intermediate optics found in prior art computed radiography plate scanning systems is avoided. Many problems associated with optical misalignment, dust, vibration, leading to temporary misalignment, and lack of scan linearity is reduced if not eliminated.

A very difficult manufacturing problem is how to precisely position thousands of fine optic fibers, e.g., less than 100 microns in diameter, adjacent to one another in a small arcuate array and have the other ends of the fibers precisely positioned in a linear array side-by-side to be aligned over small adjacent pixel areas of the radiographic medium. This is achieved in the present invention by winding the fibers to be precisely positioned side-by-side to one another about the cylindrical peripheral surface of a cylindrical drum support and then bonding the fibers to the drum support such as with a potting material. Then, the drum is cut longitudinally and cuts the wound fibers to have ends. One longitudinally cut end of the drum is formed into an arcuate support such as a cylinder and the other longitudinal cut end is disposed to extend linearly. Thus, the first end of the fibers are disposed and held in an arcuate array with the opposite second cut end of each fiber disposed linearly at linear end of the support. The respective first and second cut ends are polished.

In addition, the only moving parts, effectively speaking in the optical train are the plate feeding mechanism and the laser. No other of the optical components are separately movable which might lead to misalignment problems.

A further advantage of the present invention is that the system allows the use of standard power and networking interfaces to allow easy transfer of information from the system to a personal computer such as a laptop computer for generation of an image. The apparatus also can be used as part of a larger radiography system should it be so desired.

It is a principal aspect of the present invention to provide a high resolution radiographic imaging apparatus.

Other aspects and advantages of the present invention will become obvious to one of ordinary skill in the art upon a perusal of the following specification and claims in light of the accompanying drawings.

### BRIEF DESCRIPTION OF THE DRAWINGS

FIG. 1 is a block diagram of an apparatus comprising a computed radiography plate scanner and embodying the present invention;

FIG. 2 is a detailed view of an orientation of a transmitting fiber and a receiving fiber of the apparatus shown in FIG. 1;

FIG. 3 is an exploded perspective view of the apparatus shown in FIG. 1 showing details of a transmitting optical fiber array and a receiving optical fiber array positioned over a computed radiography plate;

FIG. 4 is a diagrammatic view of a layout of the transmitting optical fibers with respect to larger receiving optical fibers of the apparatus shown in FIG. 1;

FIG. 5 is a sectional view of the apparatus shown in FIG. 1 shown partially in schematic and showing a light path through the apparatus;

FIG. 6 is a perspective view of the apparatus shown in FIG. 1;

FIG. 7 is a sectional view of an alternative apparatus embodying the present invention;

FIG. 8 is a schematic diagram of another alternative embodiment of the present invention;

FIG. 9 is a perspective view of still another alternative embodiment of the present invention;

FIG. 10 is another perspective view of an apparatus shown in FIG. 9;

FIG. 11 is a section taken substantially along line 11-11 of FIG. 10;

FIG. 12 is a section of a portion of the apparatus shown in FIG. 9 showing details of transmit optical fibers and a receive light pipe in proximity with a CR plate being read;

FIG. 13 is a block diagram of the apparatus shown in FIG. 9;

FIG. 14 is a perspective schematic view of a portion of the apparatus shown in FIG. 9 including details of a laser, a rotatable carrier carrying the laser, a lens train, and the transmit optical fibers;

FIG. 15 is a representation of single fiber excitation in a high resolution mode;

FIG. 16 is a representation of multiple fiber illumination in a low resolution, fast scanning mode;

FIG. 17 is a diagrammatic view of another embodiment of the invention having separated erasing devices;

FIG. 18 is a view showing diagrammatically a modular construction for the transmit optical fibers for plates of different sizes; and

FIG. 19 is a diagrammatic view of an endless belt system embodying the invention therein.

### DETAILED DESCRIPTION OF THE PREFERRED EMBODIMENTS

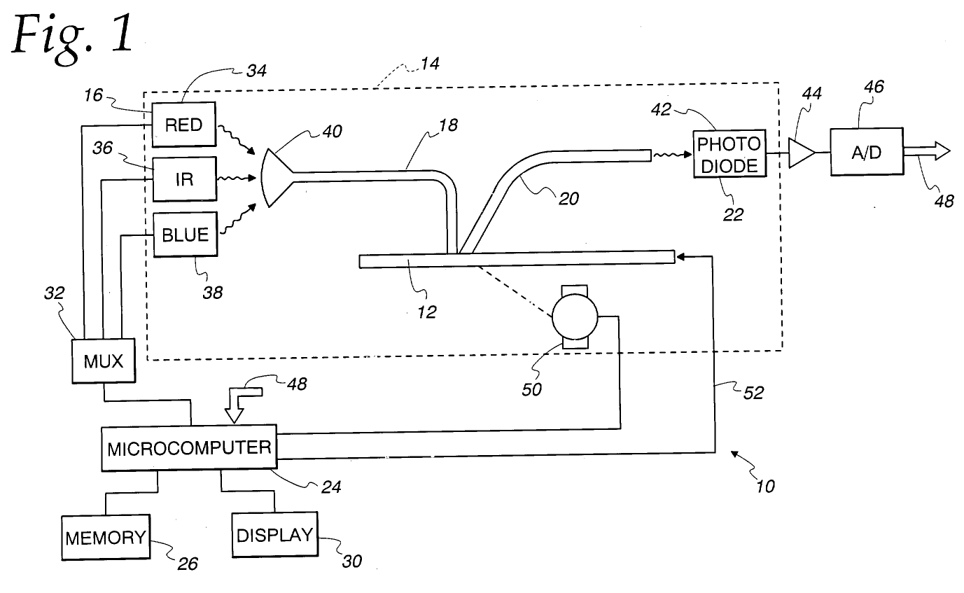

Referring now to the drawings and especially to FIG. 1, an apparatus embodying the present invention and generally identified by reference numeral 10 is shown therein. The apparatus 10 comprises a computed radiography plate scanner for use in scanning an exposed computed radiography plate 12, which may be a computed radiography plate or a computed radiography sheet. The computed radiography plate scanner 10 produces a visible image of the latent X-ray image stored on the computed radiography plate 12. The computed radiography plate or sheet 12 is normally held in a light-tight cassette but is removable from the cassette for reading or scanning.

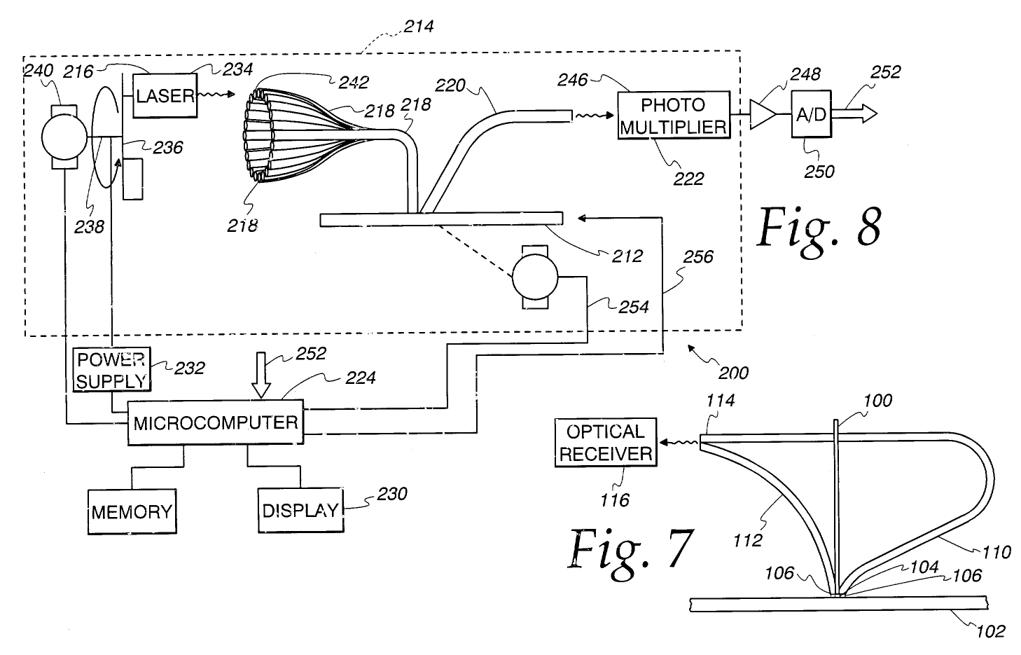

The apparatus 10 comprises a light-tight enclosure 14 for holding the computed radiography plate 12 during scanning. An optical pump source 16 (FIG. 1) or a laser pumping light source 216 (FIG. 8) produces pumping light to be delivered to the computed radiography plate 12 in order to generate phosphorescence in response to a latent x-ray image formed therein. The pumping light is carried from the optical pump source 16 through a plurality of transmit optical fibers 18 to the vicinity of the substrate 12. A second plurality of optical fibers 20, more specifically a plurality of optical receive fibers, receives localized light produced by phosphorescence from the optical pumping source 16 and delivers that phosphorescent light to an optical receiver 22. The optical receiver 22 converts the received phosphorescent light from the second fiber array 20 to an electrical signal which is supplied to a processor 24. The processor 24, in conjunction with a memory 26, generates a display of the latent image formed on the computed radiography plate 12 by previous X-ray exposure.

A housing 28 holds and defines the light-tight enclosure 14. Within the housing 28 is the processor 24 which is more specifically a microprocessor or a microcomputer. A display 30 is connected to the processor 24 to provide a visual readout to a user. The processor 24 preferably may be a microprocessor or a microcomputer The processor 24 controls operation of the optical pump source 16 via a multiplexer 32. The multiplexer 32, under the control of the processor 24, selectively energizes a red pumping light emitting diode 34, an infrared pumping light emitting diode 36 or a blue light-emitting diode 38 of the optical pump source 16, either one at a time or simultaneously. This is done in order to transmit pumping light or calibrating light to a lensing body 40 of one of a 25-50 micron optical fiber of the plurality of transmit optical fibers 18 for delivery of pumping light to the computed radiography substrate 12. Received light creates phosphorescence at a pixel on the plate 12 which was exposed to X rays and is carried along one of the receive fibers 20 to the optical receiver 22, which comprises a photodiode 42. The photodiode 42 converts the phosphorescent light to an electrical image signal.

An operational amplifier 44 amplifies the electrical image signal and feeds an amplified analog received phosphorescent light signal to an analog-to-digital converter 46 which provides a digital output signal. The digital output signal is on a bus 48 indicative of the spot density or spot intensity. In addition, the computed radiography plate or sheet 12, which is held within the light-tight enclosure 14, is moved by a stepper motor 50, under the control of the processor 24, past the optical fiber arrays 18 and 20 to cause the plate 12 to be scanned. The processor 24 then provides output signals on an output position bus 52 indicative of the position being read on the sheet 12. The position is indicated both transversely with respect to the optical arrays 18 and 20, and longitudinally with respect to the travel of the sheet 12.

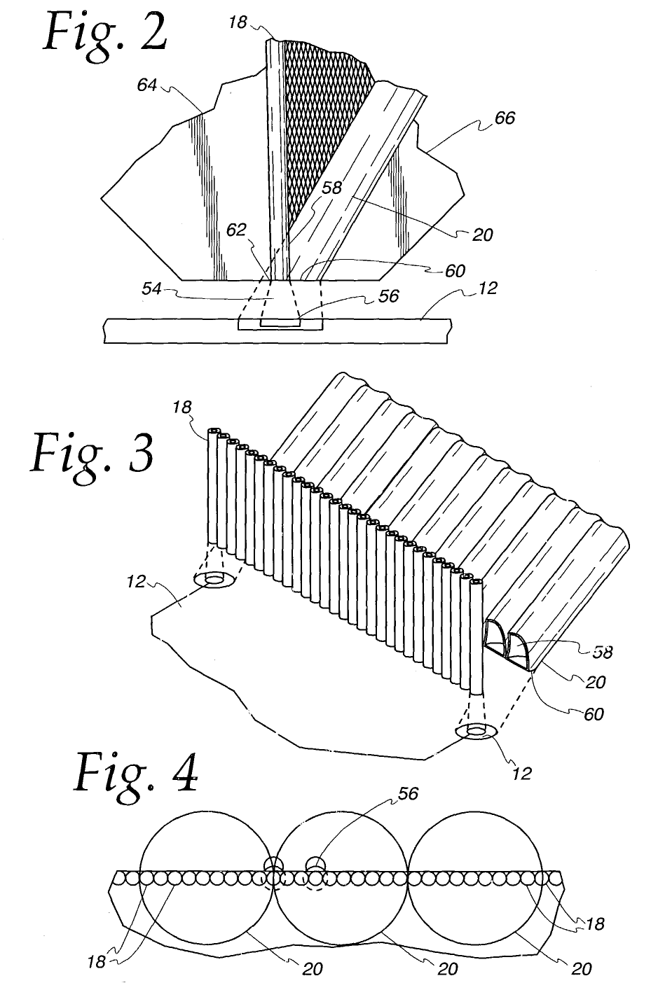

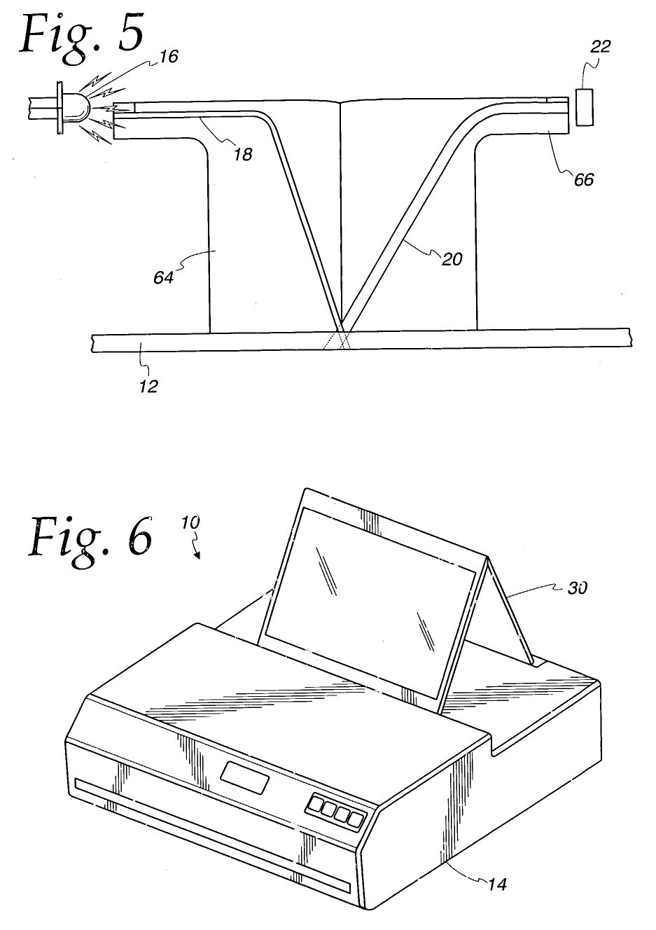

The method and the apparatus in the FIG. 1 embodiment employs multiple light emitting diodes, one of which can emit light having a wavelength of 940 nanometers or in the near-infrared region. The second diode, emits light having a wavelength between 630 and 650 nanometers in the red region. The third diode emits light in the blue region. The diodes are each coupled to a separate 50 micron diameter clad optical fiber used as a transmission fiber. The transmission fiber delivers the infrared, the red, or the blue light to the computed radiography plate 12, as may best be seen in FIG. 2. It is preferred to use, if available, 25 to 50 micron clad fibers 18 extends substantially perpendicular to the computed radiography plate 12 and emits a fan-like beam 54 of infrared or red light which strikes the computed radiography plate 12 at a spot 56. The area immediately around the spot 56 is excited by the pumping light and emits light by phosphorescence. The amount of phosphorescent light emitted is dependent upon the amount of X-ray energy stored at the point on the computed radiography plate 12.

The phosphorescent light is collected by a clad optical receive fiber 20 which extends away from the plate 12. It is preferred to use a 500 micron clad diameter clad receive fiber 20, if available. Currently, manufacturers only supply fibers with about a 33 micron core and about a 33 micron polyamide cladding or coating about the core resulting in a 65 to 67 micron fiber. The receive fiber 20 has a vertical matching face 58 and a light receiving face 60 to allow a lensing region 62 of the transmit fiber 18 to be positioned very close to the collection face 60 of the receive fiber 20 to provide extremely high image resolution. The transmit fiber 18 is one of approximately 8,000 transmit fibers, as may best be seen in FIG. 3. The transmit fibers 18 each may be separately excited by a light-emitting diode.

The plurality of transmit fibers 18 is supported by an aluminum transmit base plate or support bar 64, in order to maintain the fibers 18 in registration and in linearity so that they will be positioned a relatively short distance above the computed radiography plate 12. The computed radiography plate 12 is moved by the stepper motor underneath the fiber arrays 18 and 20 allowing rapid scanning of the computed radiography plate 12. In addition, the receive fibers 20 are supported by a receive fiber plate or support arm 66, which is composed of aluminum.

Another advantage of the present invention is that through the use of LEDs to provide pumping light, the pass bands are broad enough that they need not be specifically tuned to a specific frequency. The broad band LED outputs transfer energy to which the various computed radiography plates are sensitive. In addition, the transmit and receive optical fiber arrays 18 and 20 can be calibrated by providing blue light through the transmitting fibers 18 and then collecting the light through the receive fibers 20 to determine the exact registration of the blue light which is being provided to the computed radiography plate 12.

In effect, three LEDs are provided through a lensing system to feed the transmit fibers 18. This provides a great deal of convenience because, due to the multiple frequencies of the LEDs, different types of computed radiography plates can be used in a single scanner.

Furthermore, emission can take place in both the infrared and the visible red band simultaneously so that any type of computed radiography plate can be read. Through the use of the transmit fiber optics, the light can be focused precisely on the computed radiography plate 12 to reduce the pixel size to about 50 microns.

Furthermore, the transmitting fibers 18 are energized in multiple units; however, only every sixty-third or sixty-fourth fiber in the transmit fiber array 18 is energized at a time to provide a wide distance between simultaneously energized fibers. This avoids crosstalk between energized spots on the computed radiography plate 12. The multiple energization through the transmit optical fibers 18, however, provides very rapid response back through the receive fibers 20 while avoiding crosstalk and smearing of the image at the computed radiography plate 12. The received light, coming into the 500 micron receive optical fibers 20, is then received by separate photodetectors 68 which generate a received light signal. The received light signal is then amplified in the operational amplifier circuit. The operational amplifier provides a low-noise signal to an analog to digital converter which, in the present embodiment, has sixteen bits of resolution and provides a sixteen-bit intensity signal for further processing for displaying an image or the like.

In order to provide the highly-accurate spot sizes, the receive fiber 20 ends are polished flat in order to allow them to be seated against the transmit fibers 18 without distorting the transmit fiber array 18 line into a catenary or sine-wave line, which would lead to distortion in the excitation areas on the computed radiography plate 12. Further, the transmit fibers 18 are held in alignment by the transmit support bar 64 (FIG. 2) to which they are attached even though they are brought into intimate contact or very close to the receive fibers 20. Likewise, the receive fibers 20 are rigidly held by the receive fiber support bar 66 and then both the receive fibers 20 and the transmit fibers 18 are covered with a potting compound or a suitable opaque compound 70, which prevents light from entering the fibers 18 and 20 through their sides, thereby reducing crosstalk, and holds them rigidly over a wide range of temperatures. The fiber ends and the plate 12 are spaced and held at a closely spaced, substantial constant gap of about 0.001 to 0.003 inch from each other. The light from the transmit fibers has a core angle of about 22° from the end of the fiber to the underlying plate in the preferred embodiments of the invention. The fiber ends could be supported by an air bearing at about 0.0015 to 0.0020 inches above the computed radiography plate 12 being scanned. By closely positioning the fiber ends and maintaining a substantially constant gap between the fiber ends and the plate 12, there is achieved a high resolution scanning by reducing or eliminating the spot overlap at the computed radiography plate 12.

Furthermore, through the use of the multiple LEDs 34, 36, and 38 and the multiple transmit fibers 18, the blue LED 38 can be used to monitor, using non-phosphorescent-generating or normalizing light, in order to determine if an LED has gone out. This would be indicated by the normalization data going out of range rapidly.

Furthermore, the use of the multiple transmit fiber elements 18 enables the adjacent small micron pixel regions on the computed radiography plate 12 to be energized individually and allows determination of the degree of blooming or smearing noise or residuals.

As may best be seen FIG. 7, in an alternative embodiment of the present invention apparatus or a computed radiography scanner 99 having a plurality of excitation or transmit optical fibers, as exemplified by a pumping or excitation fiber 100 having a core diameter of about 27 microns, supplies a pumping light to a substrate 102, which may be a computed radiography plate or sheet, in a light cone 105. Phosphorescent emissions 106 may be received back by a first receive fiber 110 and a second receive fiber 112 on opposite sides of the excitation fiber 100. In order to capture more of the emitted phosphorescent light from the computed radiography plate 102 the receive optical fibers 110 and 112 may be combined at a receive fiber junction 114 to supply a larger optical output for ultimate detection by an optical receiver 116.

Referring now to FIG. 8, another alternative embodiment of the present invention is shown therein and generally identified by reference numeral 210. It comprises a computed radiography scanner for use in scanning an exposed computed radiography substrate 212, which may be a computed radiography plate or a computed radiography sheet. Such a computed radiography plate or sheet 212 is normally held in a light-tight cassette but is removable for reading or scanning.

The computed radiography scanner 210 comprises a light-tight enclosure 214 for holding the computed radiography plate 212 during scanning. An optical pump source 216 produces pumping light to be delivered to the plate 212 in order to generate phosphorescence in response to a latent X-ray image formed therein. The pumping light is carried from the optical pump source 216 through a plurality of transmit optical fibers 218 to the vicinity of the substrate 212. A second plurality of optical fibers 220, more specifically a plurality of optical receive fibers, receives localized light produced by phosphorescence stimulated by the optical pumping light and delivers that phosphorescent light to an optical receiver 222. The optical receiver 222 converts the received phosphorescent light from the receive optical fibers 220 to an electrical signal which is supplied to a processor 224. In conjunction with a memory 226, the processor 224 generates a display signal representative of the latent image from the computed radiography sheet 212.

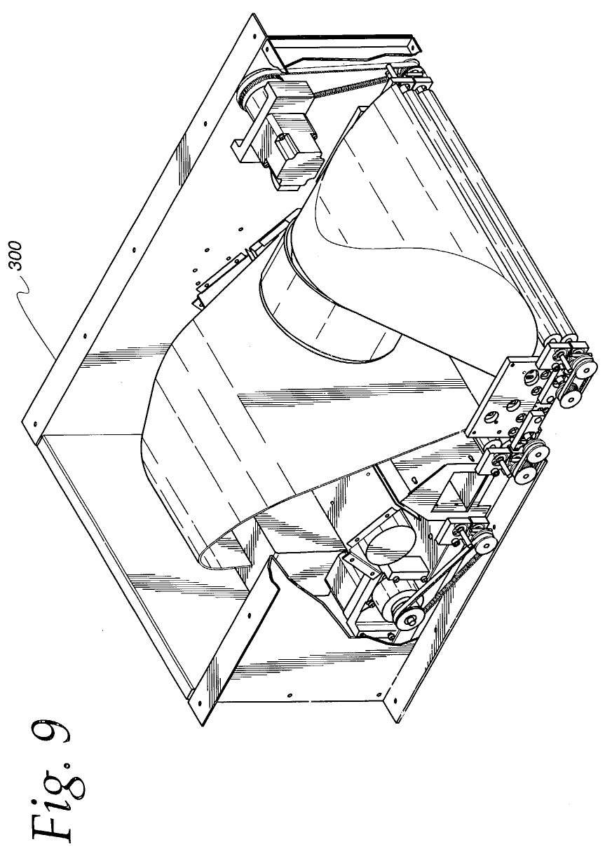

A housing 300 (FIG. 9) holds and defines the light-tight enclosure 214. Within the housing is the processor 224, which is, more specifically, a microprocessor or a microcomputer, but may also be embodied in a custom integrated circuit or the like. The memory 226 is connected to the processor 224 and may be used to store instructions and/or data. A display 230 is connected to the processor 224 to receive the display signal therefrom and in order to provide a visual reconstructed image of the phosphorescent image, which itself is representative of the latent X-ray image. More specifically, the display 230 displays a visible image counterpart to the latent image formed on the computed radiography plate 212 by the X-ray exposure. The processor 224 controls the optical pump source 216 via a power supply 232. The power supply 232 energizes a helium-neon laser 234 carried on a circular platform 236. The circular platform 236 is rotatable about a shaft 238 by a DC servo motor 240 under the control of the processor 224.

The optical receive fibers 220 are substantially identical to the optical receive fibers 20. With the exception that the optical fibers 218, receive, at a plurality of circularly-arranged input fiber ends 242, laser light from the laser 234 which is scanned by the rotating turntable 236 to inject the laser pumping light directly and serially into each of the transmit fibers 218. This causes a pumping light raster scan to take place across the transmit fiber array 218 at the computed radiography plate 212. The raster scan through the small diameter transmit fibers 218 ensures that high resolution optical excitation is provided to the computed radiography plate 212, thereby providing a high resolution phosphorescent signal to the receive fiber array 220. This ultimately enables the creation of a high resolution image by the display 230.

In order to provide further gain in the computed radiography scanner 210, the optical receiver 222 comprises a photomultiplier tube 246, which is connected to an amplifier 248. The photomultiplier tube 246 provides an image signal which is amplified by an amplifier 248 to provide another image signal comprising an analog amplified image signal. The amplifier 248 is connected to an analog to digital converter 250 which converts the analog amplified image signal to still another image signal comprising a digital image signal and sends the digital image signal on an image signal bus 252 to the processor 224 for display of the visible image on the display 230.

The computed radiography plate 212 is moved with respect to the transverse raster scanning direction by a stepper motor 254 under the control of the processor 224, to which it is connected. The position of the computed radiography plate 212 is sensed and a plate location signal is sent to the processor 224 over a line 256. This allows the processor 224 to create a high resolution digital image from the phosphorescent light being returned from the computed radiography plate 212.

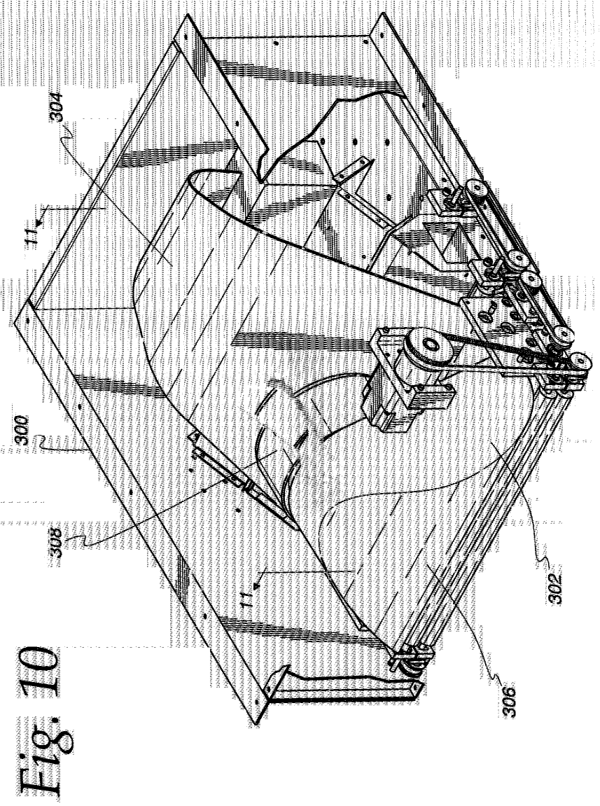

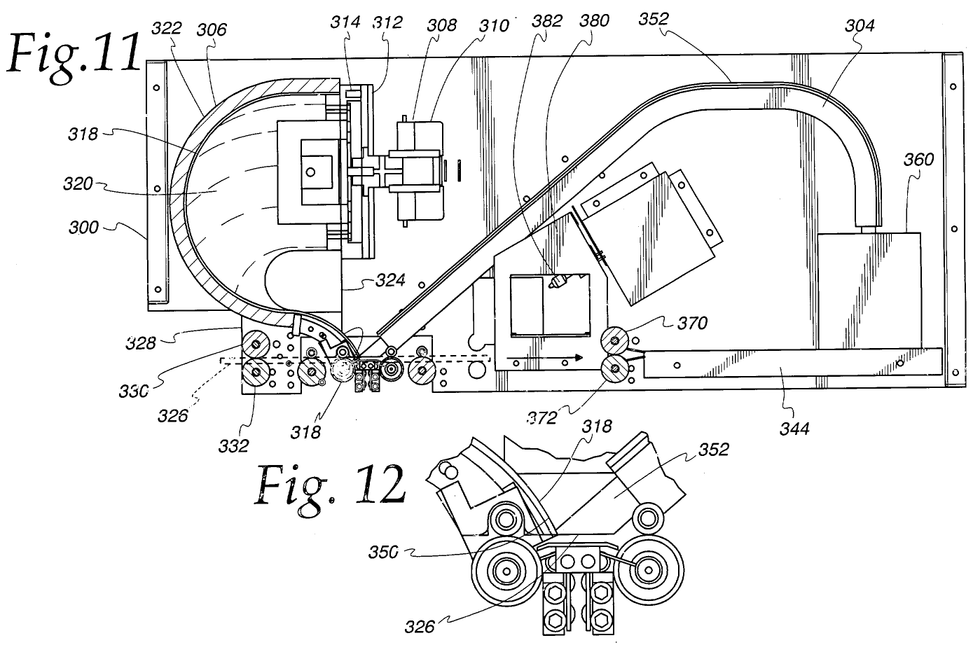

An apparatus 300, as shown in FIGS. 9 and 10, comprises still further embodiment of the present invention includes a light transmitting unit 302 and a light receiving unit 304. The light transmitting unit 302 has an optical fiber section 306 with a drive and laser illuminator section 308 associated therewith. As may best be seen in FIG. 11, an electric motor 310 has its drive shaft connected to a circular carrier plate 312 having a laser 314 positioned thereon for emitting or launching laser pumping light into a plurality of transmit optical fibers 318. The transmit optical fibers 318 comprise fibers of about 65-67 O.D. with a 33 micron core, in this instance, and are formed originally on a cylindrical drum 320, a portion of which is cut off and present in the system.

The optical fibers 318 are wound from a single fiber around the drum 320 and approximately 8,000 fibers are provided thereon. The drum 320 is then covered with a outer wall layer of sold material 322 such as of a potting compound material that holds the fibers against a shifting or vibrating. The outer wall and fibers are then cut along a cut line 324 in the manufacture of the O-rim 320 with the fiber 318 thereon. The optical fibers 318 exit the bottom of the drum in a substantially linear array as shown in FIGS. 11 and 12.

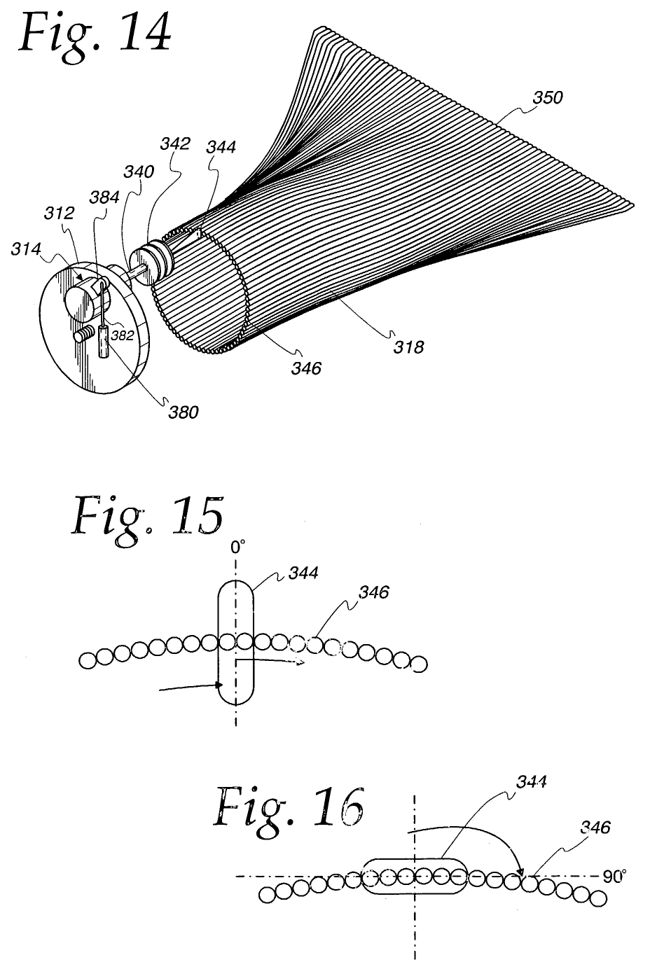

The fibers 318 are positioned closely with a computed radiography plate 326 which may enter an inlet 328 of the system 300, pass over a pair of guide rollers 330 and 332 which are powered to drive the plate 326 toward the region where the optical fibers 318 terminate in a linear array. At that region light from the laser 314 is carried sequentially down the optical fibers 318 as the laser 314 is rotated with respect to the optical fibers 318 and, as may best be seen in the schematic view shown in FIG. 14, allows a light beam 340 to pass through an optical train 342 consisting of a double convex lens and a meniscus or concave-convex lens. The focused pumping light is forms a substantially elliptical footprint 344 at a plurality of ends 346 of the optical fibers 318. The ends 346 are arranged substantially in a circle and receive the laser light. The pumping light then exits the optical fibers 318 at a plurality of output ends 350 where it is delivered to the computed radiography plate 326 for scanning. X-ray energy previously stored in the CR plate 326 is released as emitted light having been stimulated by the pumping light. The emitted light enters a one-piece light pipe 352 which comprises a portion of the light receiver 304. The one-piece light pipe 352 comprises a tapering transparent plastic body which sends light to an optical receiver section 360. The optical receiver section 360, as will be seen further, includes a photomultiplier 362 for receiving light emitted from the computed radiography plate 326 and developing an electrical signal therefrom.

The computed radiography plate 326 then is carried to the right between another pair of rollers 370 and 372 driven by a stepper motor and may be carried into a plate storage section 374. In other embodiments, the plate storage section 374 may be open to allow the plate to extend out the back. A continuous loop-type plate may be used in that modified scanner so that a single loop of computed radiography plate or sheet material may continuously pass through the scanner to provide continuous scanned images, for instance, in an industrial X-ray system which needs to monitor operations dynamically.

After having been scanned the CR plate 326 is carried by the rollers through a exit region from an exposure area, an eraser head 380 comprising a plurality of eraser lamps 382 illuminates the plate 326. This causes the excess or residual X-ray energy that has been stored in the plate 326 to be released as blue light thereby erasing the plate. The plate 326 will then be reversed and sent back, in FIG. 11 to the left out of the storage area, past the eraser head 380 again and the exposure are including the optical fiber 318 and the light pipe 352 and the apparatus 300 will be ready to receive an additional plate for further scanning.

The CR plate 326 may be scanned either at low speed and high resolution or high speed and low resolution. In the low speed, high resolution mode, the elliptical illumination spot on the fiber ends 346 is oriented as shown in FIG. 15 where only one or two fibers are illuminated at a time as the pumping beam is swept past. It may be appreciated that a major axis of the illumination ellipse extends substantially along a radius of rotation of the carrier plate 312. The laser 314, however, can be rotated with respect to the carrier plate 312 by an actuator 380 connected via an arm 382 to a moment arm 384 connected to the laser 314 to cause the laser to rotate 90° about its illumination ellipse 344 so that the major axis is substantially parallel to a tangent plane to the fiber ends 346.

In this way up to ten optical fibers can be illuminated and a rapid scan can be made of the CR plate 326 albeit at lower resolution. Such rapid scans are particularly useful for processing scout shots where an initial determination is being made as to whether a lesion is in fact present or not.

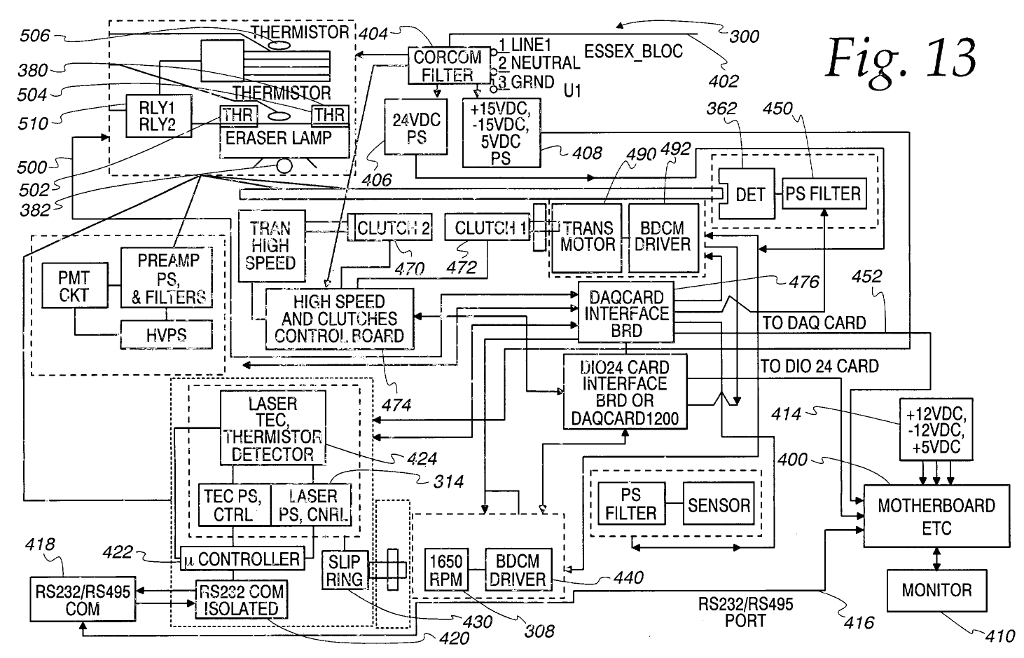

The apparatus 300 is controlled by a personal computer, which maybe a laptop, 400 as shown in FIG. 13. Power for the apparatus 300 is received from an AC line voltage source on a line 402. The power which is supplied to a filter 404 and DC power is developed by a pair of DC power sources 406 and 408 for use in other portions of the apparatus 300. The computer 400 is also connected to a display or a monitor 410 for displaying video images. The computer 400 has a separate power source 414. The computer 400 communicates with the portions of the apparatus 300 via an RS-232 or RS-495 port 416, which is connected to a communications port 418 for communication therewith. That communication port 418 conveys digital signals through an isolation section 420 to a microcontroller 422 which is mounted on the rotatable carrier plate 312 and is used to control the laser 314 and also to detect laser temperature functions via a module 424. Feed signals are supplied to the microcontroller 422 via a connection through a slip ring section 430 and the microcontroller 422 and the laser 314 are rotated by the motor 308 controlled by a motor controlled driver 440.

The photomultiplier 362 has its output filtered by a filter 450 and a signal is ultimately supplied through an interface board to the computer 400 over a bus 452. The apparatus 300 also allows control from the computer 400 of a pair of clutches 470 and 472 for control of the rollers through a high speed clutch control 474 coupled via an interface card 476 to the processor. A stepper motor 490 controlled through a motor control circuit 492, coupled through the interface cards to the computer 400, controls scanning, storage and retrieval movement of the computed radiography sheet 326 through the apparatus 300.

The interface card 476 is also connected via a control bus 500 to the eraser lamps 382 of the eraser 380. A plurality of thermistors 502, 504 and 506 supplies signals back through the interface card to the computer 400 to warn of over temperature conditions. In the event of such over temperature the computer 400 will cause the eraser lamps 382 to be shut down to avoid damage to the apparatus 300 or the computed radiography sheet 326. The eraser lamps 382 are controlled through relay circuits 510 connected through the interface board 476.

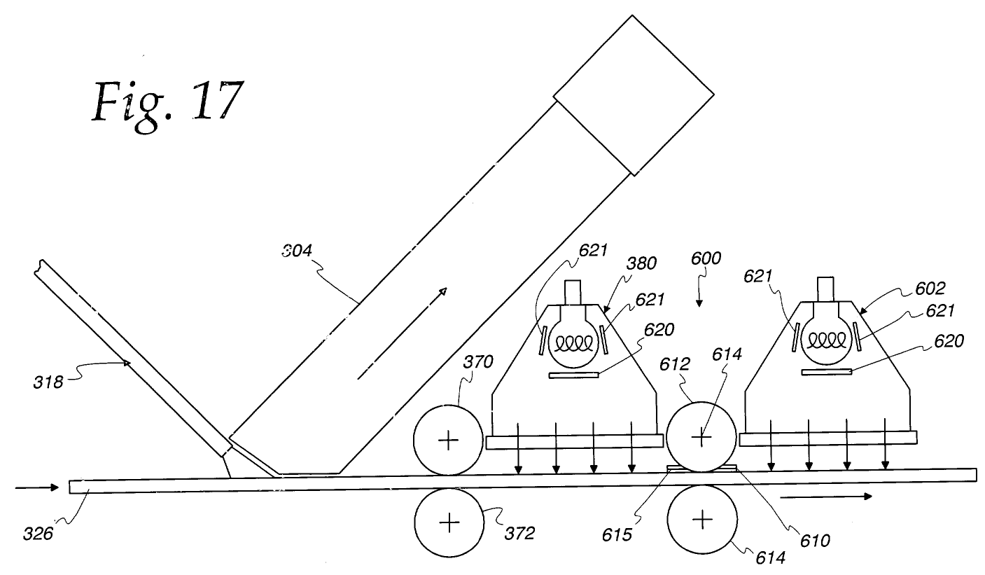

In accordance with a further aspect of the invention, the erasing of the residual latent image is providing multiple erasing operations separated to provide a relaxation period of time between successive exposures to the erasing light. The energy stored in the plate 326 is erased or removed by about two-thirds by the optical pumping light and the subsequent phosphoresce. This leaves about one-third of the latent energy still present as a residual image on the plate prior to erasing. As described hereinbefore, current erasing of these plates has heretofore been done or separate machine. Also as described hereinbefore, some objects create latent areas or lines that are difficult to erase and often leave ghosts on the plate. The erasing operation seems to follow a hyperbolic like curve where it is difficult to erase all of the latent image. It has been found that a brief relaxation, e.g., three to ten second, between successive erasures is effective in obtaining superior erasing of the faint ghosts that would otherwise be present if no relaxation period is used. Thus, for example, as shown in FIG. 17, a first erasing station 380 is separated by a gap or space 600 from a second erasing station 602. A light seal 610 in the form of a roller 612 rotates about a horizontal axis 614 and is mounted in this instance, also to hold the plate 326 down against an underlying roller 614. A first light seal in the form of an upper rotating roller 370 seals against the pumping light and emitted light from entering the first erasing device 380. The first light sealing roller 370 also holds the plate 326 tightly against the underlying roller 372 to assist in precisely positioning the plate at the desired tolerance or gap, e.g., 0.003-0.004 inch gap between the plate 326 and the adjacent ends of the light emitting fibers 318 and the light pipe 304.

In the embodiment of FIG. 17, the portion of the plate 326 erased in the first erasing device 380 travels in darkness for about a 3 to 10 second interval for relaxation at the molecular level, under a horizontally, ending cover plate 615 that extends between the first erasure device and the second erasure device and is parallel to and spaced slightly above the top surface of the plate. The molecular energy relaxes while the plate portion is in the dark while under the dark cover plate 615.

Although the erasing devices may vary in design, an inexpensive erasing device 380 or 602 for use in the machine described herein is formed of about eight or nine projection bulbs 382, e.g., one inch bulbs of white light, a filter 620 and a reflector 621 (FIG. 17). Herein, the preferred filter 620 provides orange light to the plate that is effective in erasing plates, particularly those containing barium. Other plates having other rather earth elements may be erased with white light.

Preferably, the bulbs may be spaced about one inch from the plate 326. The reflectors 621 about the bulb provide a very even and intense light across the plate. For the other plates, where a white light is used, the filters are not needed.

In accordance with a further aspect of the invention diagrammatically illustrated in FIG. 19, the radiographic plate 326 could be an endless belt or a sheet on an endless belt 625 that leaves the erasing heads 380 and 602 and travels to an x-ray station 626 having an x-ray head 627 which x-rays the part, e.g., a turbine blade 629 or the like with the latent x-ray image then traveling in a loop and entering the scanning station 630 and traveling past the scanning transmit fibers 318 and receive pumping light emanating from the rotating laser 31. A light pipe 352 delivers emitted light to the optical receiver section 360. After scanning the impeller blade object, the endless radiographic belt can then travel past the multiple erasing devices 380 and 602 separated by the cover plate 615 with a relaxation period therebetween to erase the last residual, usually about one-third of the x-ray image energy. The now erased portion should be free of ghosts or residual image and can travel about the endless path back to the x-ray station 626 for the x-raying operation to apply a new x-ray latent image on the just erased plate 326 on the endless radiographic belt.

In accordance with a further aspect of the invention, the size of the apparatus described herein may be quite small and light weight compared to some of the conventional apparatus. The illustrated circular-arrayed, ends of the transmit fibers 318 is, by way of example, only 2.9 inches in diameter and the opposite ends 350 of the fibers 318 extend linearly for only about 8.2 inches for the typical plate 326. The device may be made modular in that if only one-half of head has a semicircular array of fibers 318 than the transmit fiber ends 350 will extend linearly about 4.1 inches in length. For an 8.2 inch width of scanning on the plate 326, a full circle array of transmit fibers are provided on the 2.9 inch diameter drum and the transmit fiber ends extend linearly for 8.2 inches. Two substantially transmit fiber drums may be placed axially end to end to provide a linear extent of about 16.4 inches of transmit fiber ends 350 extending across a wide sixteen inch plate. Thus, the same shaft with two laser heads 314 may be used with two 2.9 inch diameter heads disposed axially side-by-side for scanning 16.4 inch wide plate 326.

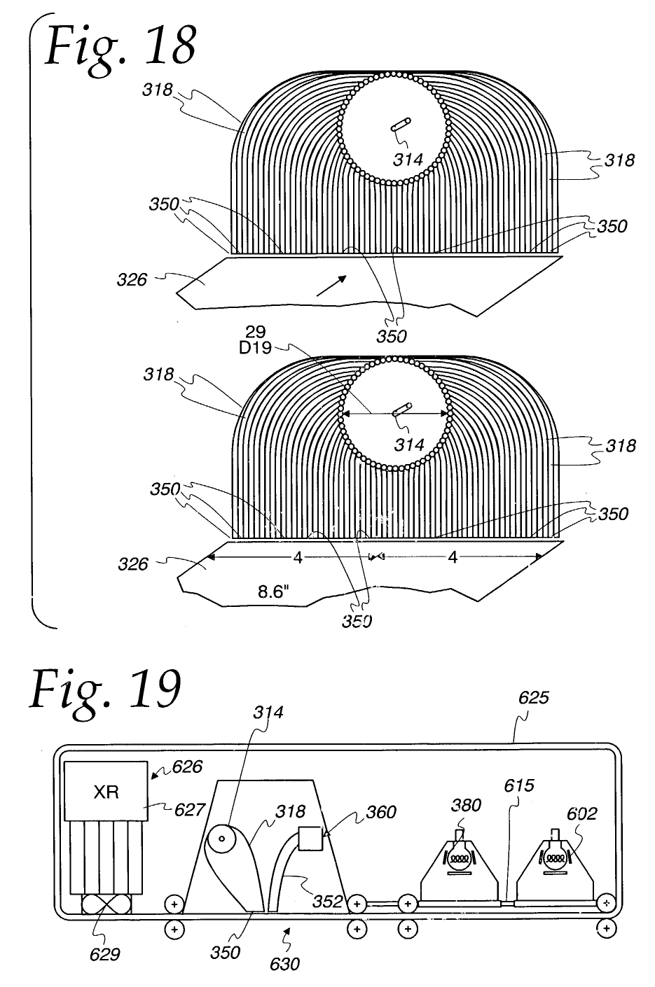

By way of example only and not by way of limitation, the apparatus shown in FIGS. 7-18 has a measurement of about 13 inches in length, 13 inches wide and 14 inches in height in contrast to the conventional machines which often are several times larger in volume. This smaller more rugged apparatus will typically weigh about 180 pounds or less compared to some conventional units that may weight about 700 pounds. Obviously, the smaller more rugged device of the present may be more readily carried by troops into combat or by other persons packing equipment into remote rugged areas in the field. The ability to erase latent images from the plates in the machine also means that fewer plates have to be transported into combat or the field than with present machines lacking an erasing operation or feature.

By way of example only and not by way of limitation, this small size imaging and scanning device of the preferred and illustrated embodiment of the invention uses a 1000 milliwatt laser that is energized to about 200 or 250 milliwatts in use. The laser light used for these barium containing radiographic plates is in the range of about 1020 to 1025 nanometers, that is in the U.V. range. For other plates, the laser light used for the phosphorescing is in the range of about 670 nanometers. Also, by way of example only and not by way of limitation, it is preferred to rotate the laser head at about 6600 rpm and to synchronously feed forward the plate so that it is scanned in about 60 seconds. The respective scanning head motor and the linear drive for feeding the plate 326 are synchronous drives so that the rotation speed and the plate travel speed are kept at a constant value relative to another throughout the scanning of the plate. Thus, it will be seen that the only effective moving parts involved in the light train to and from the plates are the laser turned by its motor and the plate 326 moved forwardly rectilinearly by its motor. Thus, vibrations that effect mirrors in the light train or cause misalignment problems in the prior art machines are avoided with this invention.

In the preferred embodiment of the invention, an optical glass fiber of the desired diameter, for example, 0.065 to 0.067 inch diameter, is wound with adjacent windings touching but not overlapping on a cylindrical drum. After the fiber winding, the fiber is then potted or bonded on the drum so that it will not shift and so that it will retain its precise side-by-side position. The drum wall is then cut longitudinally to form first and second ends for the slit, that is cut drum. Each fiber winding on the drum now has two cut ends disposed opposite one another on the respective opposite cut ends at the slit made in the drum. One cut end of the drum is rearranged into a circle to arrange the cut fiber ends thereon in the circular array. The other opposite cut end of the drum is spread linearly and the opposite end 350 of each fiber is thus also in a linear array. Thus, each fiber winding has a first end in a circular array to receive the pumping light and each fiber has an opposite end 350 in a linear array to deliver light to the radiographic medium. Herein, the first and second cut ends of the fibers are polished to either receive and deliver light. In the example given herein, the linear extent of the cut fiber end is about 8.1 inches and the diameter of the arcuate end is about 2.9 inches.

While there have been illustrated and described particular embodiments of the present invention, it will be appreciated that numerous changes and modifications will occur to those skilled in the art, and it is intended in the appended claims to cover all those changes and modifications which fall within the true spirit and scope of the present invention.

What is claimed is:

1. Apparatus for radiographic imaging and erasing the radiographic image comprising:
an optical pump source for generating light;
a plurality of optical fibers for delivering the light from the optical pump source to a radiographic medium;
an optical collector for receiving phosphorescent light from the radiographic medium stimulated by the light from the optical pump source;
an optical receiver for receiving the phosphorescent light delivered from the optical collector and producing an optical signal in response thereto;
a processor for generating an image signal from the received signals from the second plurality of optical fibers; and
a erasure device for exposing the latent image to predetermined wave lengths of light in the apparatus and then after a predetermined relaxation period for exposing the latent image a second time to erase the latent image from the sheet.

2. An apparatus in accordance with claim 1 wherein the erasure device comprises:
a first bulb source for illuminating and partially erasing the latent image; and
a second bulb source spaced from the first bulb source illuminating the remainder of the latent image after a predetermined relaxation period to erase the image further.

3. An apparatus in accordance with claim 1 comprising:
a light seal between the first and second bulb source.

4. An apparatus in accordance with claim 1 wherein the optical pump source comprises devices for generating incoherent light.

5. An apparatus in accordance with claim 4 wherein the devices for generating incoherent light comprises light emitting diodes.

6. An apparatus in accordance with claim 1 wherein the optical pump source comprises:
a laser rotating in a circle at a constant speed and producing coherent light.

7. An apparatus in accordance with claim 6 wherein the optical fibers for delivering the light from the optical pump to the radiographic medium comprise:
first ends of the optical fibers fixed in position about the rotating laser to receive light therefrom.

8. An apparatus in accordance with claim 1 comprising:
a feed device for feeding the sheet at a constant speed past optical fibers and past the erasure device.

9. An apparatus in accordance with claim 8 wherein:
the first ends of the light fibers are fixedly positioned by a potting material in an arcuate array about the rotating laser.

10. An apparatus in accordance with claim 1 wherein the optical pump source comprises:
a rotating laser rotating a constant speed; and
a feed device feeds the sheet past the optical fibers at a constant speed.

11. An apparatus in accordance with claim 1 wherein:
the optical pump source comprises a rotating laser; and
a plurality of optical fibers for delivering the light to the sheet comprises first ends of these fibers arranged in a fiber optic ring about the rotating laser.

12. An apparatus in accordance with claim 11 wherein the optical collector for receiving phosphorescent light comprises a light pipe; and
a photomultiplier is provided for receiving light from the light pipe.

13. An apparatus for radiographic imaging and erasing the radiographic image comprising:
a laser mounted for turning about a turning axis and for generating light;
a drive for turning the laser at a constant speed;
a plurality of optical fibers arranged arcuately about the turning axis for delivering the coherent light from the turning laser to a radiographic medium;
a light pipe for receiving phosphorescent light from the radiographic medium;
a feeder for feeding the plate past the optical fibers and light pipe;
an optical receiver for receiving the phosphorescent light delivered by the light pipe and for producing an optical signal in response thereto;
a processor for generating an image signal from the received signals from the second plurality of optical fibers; and
an erasing device for erasing the latent image on one portion of the radiographic plate while another portion of the plate is still receiving light from the optical fibers.

14. Apparatus for radiographic imaging according to claim 13 wherein the laser rotates and the optical fibers for delivering the light from the laser to the radiographic medium are arranged in an optic ring about the rotating laser.

15. Apparatus for radiographic imaging according to claim 13 wherein the drive for turning laser about an axis comprises a motor driven feeder for rotating the laser at a constant speed; and wherein the feeder comprises a motor driven feeder for feeding the radiographic sheet at a constant speed past the optical fibers and in the erasing device.

16. A method for radiographic imaging comprising:
rotating a pumping light source about a rotational axis at a constant speed;
arranging fiber ends in a ring about the rotating light source and receiving light and delivering light through the fibers to a radiographic medium;
receiving phosphorescent light emitted from the radiographic medium and delivering the emitted light to an optical receiver;
producing an optical signal in response to delivered emitted phosphorescent light at the optical receiver;
generating an image signal from the received signals from the second plurality of optical fibers; and
erasing a latent image from the radiographic medium.

17. A method for radiographic imaging according to claim 16, a method comprising:
rotating a laser to provide the pumping light source.

18. A method for radiographic imaging according to claim 16, a method comprising:
feeding the sheet at a constant speed past a station having the aligned ends of the light delivering optical fibers and the phosphorescence emitted light receiving optical fibers.

19. A method in accordance with claim 18 comprising:
providing an erasing station adjacent the station to erase the latent image from the plate.

20. A method of erasing a radiographic image formed on a phosphor-containing sheet by computer radiographic x-rays; the method comprising:
exposing a sample of an object to x-rays;
forming a latent x-ray image from the object on the phosphor-containing sheet;
imaging by exposing the sheet to light causing phosphoresce on the sheet and delivering emitted phosphorescent light to a processor for producing an image;
erasing a latent image on the sheet by exposure to predetermined wave lengths of light;
allowing the first erased image area to relax for a predetermined period of time; and
performing at least one additional erasing by exposure to predetermined wavelengths of light after the relaxation period.

21. A method in accordance with claim 20 comprising:
moving the sheet relative to erasure bulbs and light filters for filtering the light to provide predetermined wave lengths; and
providing a period of about three seconds or more before performing the additional erasing operation.

22. A method in accordance with claim 20 comprising:
providing a barium containing phosphor-containing sheet for forming the latent image and from which the image is erased.

23. Apparatus for radiographic imaging and erasing the radiographic image comprising:
an optical pump source for generating light;
a plurality of optical fibers for delivering the light from the optical pump source to a radiographic medium;
an optical collector for receiving phosphorescent light from the radiographic medium stimulated by the light from the optical pump source;
an optical receiver for receiving the phosphorescent light delivered from the optical collector and producing an optical signal in response thereto;
a processor for generating an image signal from the received signals from the second plurality of optical fibers;
first ends of the optical fibers being arranged in an arcuate array; and
second ends of the fibers being in a linear array to extend across the area of the radiographic medium to be imaged.

24. An apparatus in accordance with claim 23 wherein the diameter of the arcuate array is about 2.9 inches to provide a linear array extending about 8.1 inches.

25. An apparatus in accordance with claim 24 wherein a second arcuate array of fibers and a second fiber end array of fiber ends is provided side-by-side with the first ends of the first fibers for a medium of double the width of the linear extent of the first recited, second ends of the fibers.

26. An apparatus for radiographic imaging have an optical pumping source for delivering light to transmit optical fibers to deliver the light to areas on a radiographic medium, the improvement comprising:
a fiber support having an arcuate end;
at least one thousand optical fibers having first ends disposed in an arcuate array on the arcuate support end with the fibers being precisely positioned side-by-side on the arcuate end of the support,
a linear end on the support having the fiber ends arrayed in a linear array side-by-side and precisely positioned adjacent one another on the linear end of the support;
an intermediate portion on the support extending between the arcuate and the linear ends of the support for supporting the fibers in precisely positioned relationship to one another between the arcuate and linear ends of the support; and
a bonding material bonding the fibers and their respective ends to the support to prevent their shifting relative to one another on the support.

27. An apparatus in accordance with claim 26 wherein the support has a cylindrical end providing the arcuate support;
the support being in the form of a previously longitudinally cut drum having one cut end rearranged in a cylindrical and a fan-like intermediate position and the other cut end rearranged to extend linearly.

28. An apparatus in accordance with claim 26 wherein the bonding material is potting material to pot the fibers to the support.

29. A method of forming a fiber transmit head for transmitting light to cause phosphoresce of pixel areas on a radiographic medium comprising;
providing a cylindrical drum;
winding at least one thousand fibers of a small diameter on the drum in side-by-side relationship and precisely positioned relative to one another;
bonding the fibers to the drum with a bonding material to retain the fibers against shifting relative to another;
cutting the drum longitudinally and cutting the fibers thereon;
forming a first longitudinally cut end into a cylinder thereby positioning first cut ends of the fibers in an arcuate array; and
forming a linear end with the other cut drum end to have the cut fiber ends arranged linearly on the linear end.

30. A method in accordance with claim 29 comprising:
polishing the first and other ends of the fibers.

31. A method of radiographic imaging having transmit fibers having first ends to receive light from a laser and second ends delivering light to a movable radiographic medium and having a light path from the laser light pumping source to an optical receiver, the method having the light path comprising only the following moving parts:
rotating the laser relative to first ends of the transmit fibers; and
traveling the radiographic medium relative to opposite ends of the transmit fibers.

32. A method of radiographic imaging in accordance with claim 31 comprising:
rotating the laser at a constant speed;
driving the radiographic medium past the other ends of the transmit fibers at a constant speed; and
maintaining the respective speeds in synchronism with one another.
